(19) United States
(12) Patent Application Publication
(10) Pub. No.: US 2015/0363513 A1
(43) Pub. Date: Dec. 17, 2015

(54) METHOD AND SYSTEM FOR DESIGNING PRODUCTS

(71) Applicant: Wolfram Alpha LLC, Campaign, IL (US)

(72) Inventors: John Cassel, Champaign, IL (US); Jan Brugard, Linköping (SE); Stephen Wolfram, Cambridge, MA (US)

(21) Appl. No.: 14/304,645

(22) Filed: Jun. 13, 2014

(51) Int. Cl. G06F 17/50

(52) U.S. Cl. CPC G06F 17/50

(57) ABSTRACT

In a method for generating a product design, a description of i) a product to be designed, and/or ii) one or more design objectives are received and analyzed to determine a design function that corresponds to the description and characterizes the product. Combinations of sub-functions that match the determined design function are determined. A plurality of components that implement the design sub-functions are determined. One or more models that correspond to one or more candidate designs that implement the determined design function are constructed from sub-models corresponding to the determined plurality of components. The one or more models are evaluated with regard to one or more design objectives. A report is generated that provides i) information regarding performance of at least one candidate design with regard to the one or more design objectives, and/or ii) an indication that no candidate design meets the one or more design objectives, when appropriate.

### FIELD OF THE DISCLOSURE

The present disclosure generally relates to systems for facilitating product design.

### BACKGROUND

Product design is a multi-step, typically lengthy, process that is often heavily reliant on experts with in-depth knowledge of particular products or industries. An initial phase in the process, which is often heavily reliant on expert knowledge or skill, is sometimes referred to as concept generation or conceptualization. For example, a designer may draw on personal knowledge or experiences to generate product design concepts. Also, a designer may review patents of others or reverse engineer other products to understand similar designs. Such techniques are time consuming and may introduce biases and/or limit the range of generated concepts.

Typically after the concept generation phase, engineers may utilize computer-aided design (CAD) systems to create a detailed design of a product concept, and sometimes to model the design. Current CAD systems range from 2-dimensional (2D) vector-based drafting systems to 3-dimensional (3D) solid and surface modelers. Some CAD systems provide rendering and animation capabilities to help better visualize product designs.

### SUMMARY OF THE DISCLOSURE

In an embodiment, a method for generating a product design includes receiving, at one or more computer processors, a description of at least one of i) a product to be designed, or ii) one or more design objectives corresponding to the product to be designed; analyzing, at one or more computer processors, the description to determine a design function that corresponds to the description and characterizes the product; determining, at one or more computer processors, one or more combinations of sub-functions that match the determined design function; determining, at one or more computer processors, a plurality of components that implement the design sub-functions; generating, at one or more computer processors, one or more models that correspond to one or more candidate designs that implement the determined design function, including constructing each model from one or more sub-models corresponding to one or more components among the determined plurality of components; evaluating, at one or more computer processors, the generated one or more models with regard to one or more design objectives; and generating, at one or more computer processors, a report that provides at least one of i) information regarding performance of at least one candidate design with regard to the one or more design objectives, and ii) an indication that no candidate design meets the one or more design objectives, when appropriate.

In another embodiment, a system for generating a product design comprises a database of sub-models corresponding to components capable of being assembled into products, and a design description analysis module configured to analyze a received description to determine a design function that corresponds to the description and characterizes the product, wherein the description is of at least one of i) a product to be designed, and ii) one or more design objectives corresponding to the product to be designed. The system also comprises a model generation module coupled to the database and the design description analysis module, the model generation module configured to: determine one or more combinations of design sub-functions that match the determined design function, determine a plurality of components that implement the design sub-functions, and generate one or more models that correspond to one or more candidate designs that implement the determined design function, including constructing each model from one or more sub-models corresponding to one or more components among the determined plurality of components. The additionally comprises a design evaluation module coupled to the model generation module, the design evaluation module configured to evaluate the generated one or more models to with regard to one or more design objectives. The system further comprises a report generation module coupled to the design evaluation module, the report generation module configured to generate a report that provides at least one of i) information regarding performance of at least one candidate design with regard to the one or more design objectives, and ii) an indication that no candidate design meets the one or more design objectives, when appropriate.

### BRIEF DESCRIPTION OF THE DRAWINGS

FIG. 1 is a diagram of an example system for facilitating product design, according to an embodiment.

FIG. 2 is a flow diagram of an example method for designing products, according to an embodiment.

### DETAILED DESCRIPTION

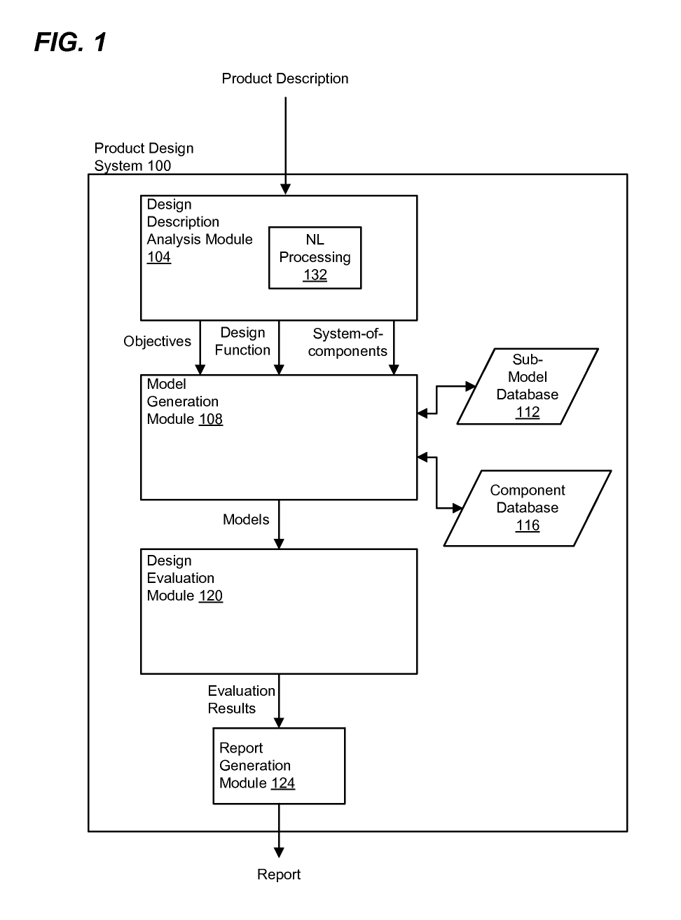

FIG. 1 is a diagram of an example product design system 100, according to an embodiment. The product design system 100 may assist a designer, engineer, lay person, etc., in designing products such as mechanical devices, electrical devices, electro-mechanical devices, nanomachines, pharmaceutical products, etc. The product design system 100 may be implemented on a single computer, by a network of computers, in a client-server system, using a cloud-based system, etc., as will be described in more detail below.

An overview of product design system 100 will first be discussed, and then a more detailed description of the various modules of the product design system 100 is provided.

The product design system 100 may include a design description analysis module 104 configured to receive a design description corresponding to a product to be designed, analyze the design description to determine a design function corresponding to the design description, and output an indication of the determined design function. In some embodiments, the design description analysis module 104 optionally may be configured to analyze the design description to determine one or more design objectives corresponding to the design description, and output an indication of the one or more design objectives. In some embodiments, the design description analysis module 104 optionally may be configured to analyze the design description to determine one or more systems-of-components corresponding to the design description, and output an indication of the one or more systems-of-components.

In some embodiments, the design description received by the design description analysis module 104 may include one or more design objectives, and the design description analysis module 104 is configured to identify design objectives included in the received design description. In some embodiments, the design description analysis module 104 additionally or alternatively is configured to determine design objectives that were not included in the received design description. For example, in some embodiments, the design description analysis module 104 is configured to determine one or more design objectives that typically correspond to a design function and/or system-of-components. As an illustrative example, the design description analysis module 104 may include a database that stores typical design objectives corresponding to known design functions and/or known systems-of-components, and the design description analysis module 104 may look up typical design objectives in such a database based on a determined design function and/or a determined system-of-components.

A model generation module 108 may be communicatively coupled to the design description analysis module 104. In some embodiments, the model generation module 108 may be communicatively coupled to a sub-model database 112 and coupled, additionally or alternatively, to a components database 116. The model generation module 108 may receive the indication of the design function (and optionally the indication of the one or more design objectives; and/or optionally the indication of the one or more systems-of-components) output by the design description analysis module 104. The model generation module 108 may be configured to determine one or more combinations of known design sub-functions that match the determined design function, determine a plurality of components that implement the design sub-functions, and generate one or more models that correspond to one or more candidate designs that implement the determined design function. For example, in some embodiments, the sub-model database 112 may store a plurality of sub-models corresponding to known design sub-functions. The sub-models may correspond to commercially available components capable of implementing the design sub-functions, in some embodiments. In some embodiments, information regarding commercially available components corresponding to at least some of the sub-models may be stored in the components database 116.

In some embodiments, a model or sub-model comprises machine readable information and/or instructions (e.g., software objects, software functions, etc.) corresponding to a mathematical model that simulates physical behavior of a physical apparatus, system, and/or process. Thus, the models and/or sub-models can be analyzed (e.g., evaluated, interpreted, simulated, etc.) by a processor or processors (e.g., executing machine readable instructions), in some embodiments. A processor or processors can construct models from a plurality of sub-models, in an embodiment. For example, in an embodiment, sub-models may include application programming interfaces (APIs) to facilitate interaction between sub-models and assembly of multiple sub-models to form a model.

In some embodiments, a model or sub-model comprises one or more mathematical equations that simulate physical behavior of a physical apparatus, system, and/or process, and that can be analyzed (e.g., evaluated, interpreted, etc.) by a processor or processors (e.g., executing machine readable instructions). In some embodiments, a model or sub-model comprises one or more physical models that simulate physical behavior of a physical apparatus, system, and/or process, and that can be analyzed (e.g., evaluated, interpreted, etc.) by a processor or processors (e.g., executing machine readable instructions).

More generally, in some embodiments, a model or sub-model comprises a design modeling component (e.g., a machine readable information and/or instructions corresponding to a mathematical model, one or more mathematical equations, a physical model, etc.) that simulates physical behavior of a physical apparatus, system, and/or process. Thus, the models and/or sub-models can be analyzed (e.g., evaluated, interpreted, simulated, etc.) by a processor or processors (e.g., executing machine readable instructions), in some embodiments. A processor or processors can construct models from a plurality of sub-models, in an embodiment.

The model generation module 108 may be configured to construct each model from one or more sub-models corresponding to one or more components among the determined plurality of components. For example, in some embodiments, the model generation module 108 may be configured to retrieve sub-models from the sub-model database 112 and construct models from the retrieved sub-models. In some embodiments, each constructed model may correspond to a respective candidate design.

In some embodiments, the model generation module 108 may be configured to utilize design objectives and/or systems-of-components (e.g., identified by the design description analysis module 104) to construct models.

The model generation module 108 outputs the constructed models to a design evaluation module 120, which may be communicatively coupled to the model generation module 108. The design evaluation module 120 may be configured to evaluate the models with regard to one or more design objectives. For example, in some embodiments, the one or more design objectives may be determined by the design description analysis module 104 as discussed above, based on an analysis of the received design description. In some embodiments, some or all of the design objectives may be assumed, determined based on the constructed model, etc.

The design evaluation module 120 outputs the evaluations of the models to a report generation module 124, which may be communicatively coupled to the design evaluation module 120. The report generation module 124 may be configured to generate a report that provides information regarding performance of at least one candidate design with regard to the one or more design objectives. The report generation module 124 may be configured to generate the report using the evaluations provided by the design evaluation module 120.

In various embodiments, reports generated by the report generation module 124 may be in a variety of suitable formats such as XML, a format readable by a word processing software application, a format readable by a spreadsheet software application, a format readable by a modeling software application, a format readable by the MATHEMATICA® software application, etc.

In some embodiments, no candidate design may meet the one or more design objectives. Thus, in some embodiments, the report generation module 124 may be configured to generate the report to include, additionally or alternatively, an indication that no candidate design meets the one or more design objectives, when appropriate. In some embodiments, when no candidate design meets all of the one or more design objectives, the report generation module 124 is configured to indicate one or more candidate designs that come closest to meeting all of the one or more design objectives and to indicate which design objectives were not met (and optionally an amount or degree by which a design objective was not met). In some embodiments, the report generation module 124 is configured to analyze candidate designs to provide suggestions for meeting or coming closer to meeting design objectives (e.g., “if fuel consumption of sub-system X could be improved by Y % then all objectives would be met”).

The modules illustrated in FIG. 1 will now be described in more detail.

In various embodiments, the design description analysis module 104 may be configured to analyze design descriptions having various different formats. For example, in some embodiments, the design description analysis module 104 may include a natural language (NL) processing module 132 configured to analyze one or more portions of the description expressed at least partially in NL. In some embodiments, the NL processing module 132 is configured to perform NL processing on the description (or a portion of the description expressed in NL) to identify one or more of i) design functions (e.g., “cuts grass”), ii) systems-of-components (e.g., “is a lawnmower”), and iii) objectives such as constraints (e.g., “grass is 2-3 inches tall upon cutting”) and goals (e.g., “will use as little fuel as possible”). In some embodiments, the design description analysis module 104 may be configured to map design functions identified in an NL description to systems-of-components known to implement the identified design functions. Similarly, in some embodiments, the design description analysis module 104 may be configured, additionally or alternatively, to map systems-of-components identified in an NL description to design functions known to be implemented by the identified systems-of-components.

In some embodiments, the design description analysis module 104 may be configured to map under-specified objectives to design functions and/or systems-of-components. For example, the design description analysis module 104 may be configured to map “goes 0-60 mph in 10 seconds” (under-specified objectives) to “moves itself and cargo” (design function) and/or to “car” (system-of-components).

As discussed above, in some embodiments, the design description received by the design description analysis module 104 may include one or more design objectives, and the design description analysis module 104 is configured to identify design objectives included in the received design description. Also as discussed above, in some embodiments, the design description analysis module 104 additionally or alternatively is configured to determine design objectives that were not included in the received design description.

In embodiments in which the design description analysis module 104 includes the NL processing module 132, the NL processing module 132 may include a parser configured to examine an input to extract keywords, group words into phrases, identify numerical expressions, categorize data, etc., for example. In some embodiments, the parser may perform an initial go/no go analysis on the keywords, phrases, or numerical expressions to determine if there is enough information to proceed to a further step. When there is not enough information to make even a cursory pass at further analysis, the parser may cause the user to be prompted for additional information such as information that may resolve ambiguities. Alternatively, the system 100 may generate a message that the system 100 cannot interpret the input.

In some embodiments, the parser may take an initial input and create tokens, and then assemble the tokens into one or more expressions in a precise syntax. In some embodiments, the parser may perform additional processing such as attempting to identify phrases, attempting to rearrange tokens to see if the rearrangements match something that the parser understands, such as a phrase. For instance, the parser may utilize algorithmic rearrangements of the input. Also, in some embodiments, the parser may cause the user to be prompted to rephrase the input. Then, the parser may analyze the original input in conjunction with the rephrased input. Further, the parser may utilize machine learning techniques to identify language processing algorithms that work better than others, in some embodiments. The one or more expressions generated by the parser may then be analyzed by the design description analysis module 104.

In some embodiments, the design description analysis module 104 may be configured to (additionally or alternatively to processing NL inputs) process other types of inputs such as inputs in a precise syntax, in a defined computer readable format, etc. For example, in an embodiment, the design description analysis module 104 may be configured to process information in electronic tables in known file structures. For example, constraints, objects, etc., could be listed in a table and input to the design description analysis module 104. As another example, a table could be formatted to identify, e.g., via defined table cell positions, via row and/or column headings, etc., that a particular table cell corresponds to a design function, another particular table cell corresponds to a design objective, etc.; and the design description analysis module 104 may be configured to identify particular table cells as design function or design objective using the table formatting, e.g., defined table cell positions, row and/or column headings, etc.

In an embodiment, the design description analysis module 104 may be configured to receive information via graphical user interface (GUI) mechanisms. For example, the design description analysis module 104 may be configured to prompt a user for particular types of information via GUIs such as a “wizard”, one or more menus, one or more buttons, one or more electronic forms, etc. For instance, a user could input information and identify a type of the information (e.g., design function, objective, system-of-components, etc.) via menu selections, button activations, etc. As another example, a “wizard” could prompt the user for particular types of information at particular times, in particular portions of a display. As another example, the design description analysis module 104 may provide structured electronic form in which a user can input different types of information in different input boxes on the form, for example.

In an embodiment, the design description analysis module 104 may be configured to receive and process graphical information, such as a graphical depiction of the product to be designed, a graphical representation of one or more components of the product to be designed, etc. For example, the design description analysis module 104 may be configured to receive and process digital graphics information such as in computer aided design (CAD) files corresponding to a product to be designed and/or one or more components of the product. As another example, the design description analysis module 104 may be configured to receive and process digital photographs of a product to be designed and/or one or more components of the product. As yet another example, the design description analysis module 104 may be configured to receive and process digitized hand drawings. In various embodiments, the design description analysis module 104 may be configured to process the graphical information to identify and/or determine, or help identify and/or determine design functions, systems-of-components, objectives, etc.

In an embodiment, the design description analysis module 104 may be configured to receive and process CAD files corresponding to a complete technical design a product (e.g., a current product that may act as a template or frame of reference for a new design), partial technical design information of the product, technical design information of one or more components of the product, partial technical design information of the one or more components of the product, etc. In various embodiments, the design description analysis module 104 may be configured to process the CAD files to identify and/or determine, or help identify and/or determine design functions, systems-of-components, objectives, etc.

As discussed above, the model generation module 108 may be configured to construct each model from one or more sub-models corresponding to one or more components among the determined plurality of components. In some embodiments, the model generation module 108 may utilize graph theory techniques to assemble models from sub-models. For example, in some embodiments, the model generation module 108 may be configured to assemble and/or find graphs (referred to herein as a “function graph”) corresponding to assembled design sub-functions that satisfy a design function determined by the design description analysis module 104. As another example, in some embodiments, the model generation module 108 may be configured to assemble and/or find function graphs corresponding to assembled design sub-functions that are undertaken by a system-of-components determined by the design description analysis module 104. As another example, in some embodiments, the model generation module 108 may be configured to assemble and/or find function graphs corresponding to assembled design sub-functions that could potentially meet objectives determined by the design description analysis module 104. As discussed above, the model generation module 108 may be configured to retrieve sub-models from the sub-model database 112. In some embodiments, the sub-model database 112 may also include assembled models corresponding to systems-of-components, and the model generation module 108 may be configured to retrieve assembled models from sub-model database 112.

The model generation module 108 also may be configured to construct one or more models of connected component systems which implement a given function graph determined by the model generation module 108, in some embodiments. In some embodiments, each constructed model may correspond to a respective candidate design.

The components database 116 may store general and/or supplier-specific information for physical components corresponding to sub-models (and optionally models). Information stored in the components database 116 may include cost information, reliability information, operating conditions, options for parameterization, etc.

The model generation module 108 may be configured to utilize the components database 116 to assemble models, at least in some embodiments. For example, the model generation module 108 may be configured to search the components database 116 regarding commercially available components. In some embodiments, the components database 116 may store sub-models corresponding to commercially available components; and the model generation module 108 may be configured to retrieve, from the components database 116, one or more sub-models corresponding to one or more commercially available components, and then utilize the retrieved sub-models when generating models.

In some embodiments, the model generation module 108 also may be configured to utilize inference techniques to reduce the space of models needing evaluation. For example, in an embodiment, inference techniques could be used to limit the overall space of the models over which optimization is to be performed. As another example, in an embodiment, inference techniques could be used to suggest initial candidates that might perform well.

In some embodiments, the system 100 may be coupled to multiple components databases 116 corresponding to and/or controlled by different manufacturers. In some embodiments, manufacturers may be permitted to upload information to one or more components databases 116, the uploaded information corresponding to, for example, commercially available components, sub-models corresponding to the components, cost information, reliability information, operating conditions, options for parameterization, etc. Thus, in some embodiments, as manufacturers introduce new components, the manufacturers can update components database(s) 116.

The design evaluation module 120 may be configured to determine programs of simulation and analysis of outputs to be used to assess performance of the models along objectives. The design evaluation module 120 may be configured to subject models to evaluation through simulation to determine the objective value of a design along a given parameterization and within an optimization routine to guide the search through potential parameterizations.

In some embodiments, the design evaluation module 120 may be configured to evaluate models utilizing information regarding factors external to the candidate design. For example, the design evaluation module 120 may be configured to utilize information regarding external factors such as an environment in which the product will be, or is expected to be, used, a material that the product will, or is expected to, use in operation, a system in which the product will be, or is expected to be, implemented, a condition under which the product will be, or is expected to be, operated, etc.

In an embodiment, the report generation module 124 may be configured to describe the models which satisfy functional, structural, and performance objectives, if any. In an embodiment, if satisfying models are found, the report may include the performance along requested and common considerations, focusing on models which satisfy different under-constrained trade-offs differently. In an embodiment, if no satisfying models are found, but only due to failures to meet performance constraints, the nature of the performance constraint failure might be specified, potentially along with models that meet relaxed constraints. In some embodiments, when no candidate design meets all of the functional, structural, and performance objectives, the report generation module 124 is configured to indicate one or more candidate designs that come closest to meeting all of the one or more design objectives and to indicate which design objectives were not met (and optionally an amount or degree by which a design objective was not met). In some embodiments, determining “closest” models comprises generating a suitable cost metric that indicates how close a model comes to meeting design objectives, and selecting models based on one or more of i) evaluating whether a cost metric meets a threshold, ii) a ranking of models based on cost metrics, etc. As discussed above, in some embodiments, the report generation module 124 is configured to analyze candidate designs to provide suggestions for meeting or coming closer to meeting design objectives.

In some embodiments, the report generation module 124 may be configured to provide guidance for further analyzing the models. For example, the report generation module 124 may be configured to provide further objectives common to models with a given specification. Such further objectives may permit elaboration to further objectives, external situations, requirements, etc. In some embodiments, guidance provided by the report generation module 124 may be open-ended, such as recommending one or more additional discovery processes to provide additional information.

In some embodiments, the product design system 100 may be utilized to perform interactive design. For example, when the system 100 cannot generate a model that meets all design objectives, the model generation 108 may be configured to output “best fit” models (e.g., as described above) and/or partial models (referred to herein as “intermediate models”). In some embodiments, the product design system 100 may be configured to permit and facilitate a user to modify an intermediate model, and then the design evaluation module 120 and the report generation module 124 may evaluate the modified intermediate model and report information regarding the modified intermediate model and/or the evaluation of the modified intermediate model similar to the operation of the design evaluation module 120 and the report generation module 124 discussed above. In some embodiments, the design evaluation module 120 and/or the report generation module 124 may be configured to suggest modifications to intermediate models.

For example, in an embodiment, when the system 100 cannot generate a model that meets all design objectives, the model generation unit 108 may be configured to output a partial design that performs a subset of the determined sub-functions that match the determined design function. In an embodiment, the system 100 may be configured to determine a subset of the sub-functions that best meets the design objectives. In an embodiment, the system 100 may be configured to utilize heuristics when determining the sub-set. As an illustrative example, the system 100 may be configured to “greedily” remove a sub-function to which a corresponding subsystem worst violates constraints, in an embodiment. In some embodiments, the system 100 may be configured to prompt the user to give, or otherwise receive from the user, cues indicating which subsets of design sub-functions will be acceptable, such as linguistically through designations such as “must/might” or “required/desired”, entering a preference between features via menu, giving each feature a weighted priority, adopting a previously established set of preferences, etc. As an illustrative example, given a user input “an espresso machine with separate coffee and steam boilers, foaming wand, grinding unit, a cup heater, and capacity for 5 pounds of beans, all weighing less than 2 pounds loaded and costing less than $400”, the system 100 might generate a partial design that includes an espresso machine without a grinding unit.

In an embodiment, when the system 100 cannot generate a model that meets all design objectives, the system 100 may be configured to change, at least temporarily, one or more constraints among the design objectives to “goals” (e.g., change from mandatory to aspirational) or otherwise relax the one or more constraints, and attempt to find a best fit design for the modified design objectives. In an embodiment, the system 100 may be configured to determine a subset of one or more constraints to be relaxed that allows one or more other constraints to be met. In an embodiment, the system 100 may be configured to utilize heuristics when determining one or more constraints to be relaxed. In an embodiment, the system 100 may be configured to approximate a multidimensional trade-off curve between different selections of relaxed constraint performances. In some embodiments, the system 100 may be configured to prompt the user to give, or otherwise receive from the user, cues indicating which design objectives are more important by weighting them with respect to each other and/or by decomposing a given performance requirement into multiple performance goals. As an example of such a decomposition, the user might indicate that a bridge would ideally weigh less than W′, but is strongly required to weigh less than W. Such prioritization and/or decomposition may be indicated linguistically, by menu, by adopting previous trade-offs, etc., according to various embodiments. As an illustrative example, given a user input “a bridge made of M that weighs at most W and can support Z tons,” if the system 100 determines that no design can achieve a bridge at this specification, the system 100 might be configured to determine, and inform the user, what bridge weight W′ would be required to support Z tons, that a bridge weighing W could support Z′, a material M′ which would allow both W and Z to be met, etc. Continuing with this example, the system 100 might then calculate ranges of points between (M, W′, Z) and (M, W, Z′) to demonstrate a trade-off curve or curves for different selections of weight between W and W′ and/or different selections of supported load between Z′ and Z.

In some embodiments, the product design system 100 may be configured to permit and facilitate a user to modify design objectives, and then the product design system 100 may start a new model generation/analysis process afresh, and/or the design evaluation module 120 and the report generation module 124 may evaluate an intermediate model with regard to the revised design objectives and report information regarding the intermediate model and/or the evaluation of the intermediate model similar to the operation of the design evaluation module 120 and the report generation module 124 discussed above. In some embodiments, the design evaluation module 120 and/or the report generation module 124 may be configured to suggest modifications to design objectives.

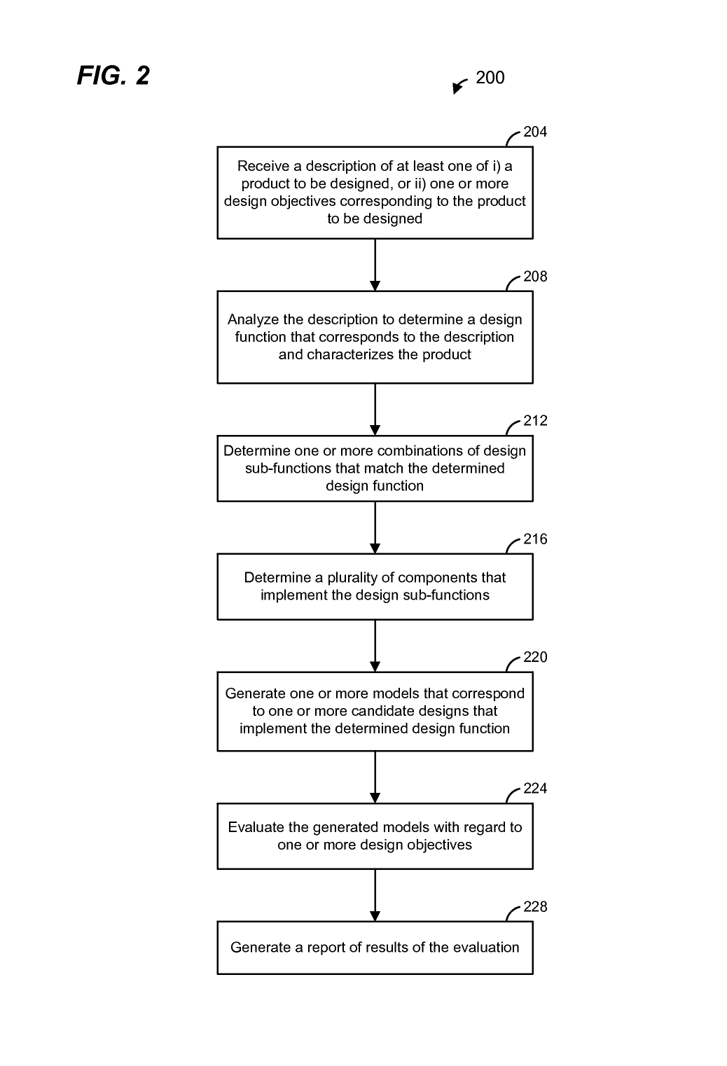

FIG. 2 is a flow diagram of an example method 200 for designing products, according to an embodiment. The method 200 may be implemented by the system 100 of FIG. 1, and FIG. 2 is described with reference to FIG. 1 for illustrative purposes. The method 200, however, may be implemented by other suitable systems. Similarly, the system 100 may implement other suitable methods.

At block 204, a product design system receives a description of at least one of i) a product to be designed, or ii) one or more design objectives corresponding to the product to be designed. For example, the design description analysis module 104 may be configured to receive a description in various and/or multiple formats as discussed above, in various embodiments.

At block 208, the description is analyzed to determine a design function that corresponds to the description and characterizes the product. For example, as discussed above, the design description analysis module 104 may be configured to analyze a received description to determine a design function that corresponds to the description and characterizes the product.

Optionally, in some embodiments and/or scenarios, the description may be analyzed also to determine or identify the one or more design objectives. For example, as discussed above, the design description analysis module 104 may be configured to analyze the received description determine or identify the one or more design objectives.

At block 212, one or more combinations of design sub-functions are determined that match the design function determined at block 208. For example, as discussed above, the model generation module 108 may be configured to determine one or more combinations of design sub-functions are determined that match the design function. Block 212 may include using graph theory techniques as described above, in some embodiments.

At block 216, a plurality of components that implement the design sub-functions are determined. For example, as discussed above, the model generation module 108 may be configured to determine a plurality of components that implement the design sub-functions. Block 216 may include interrogating and/or retrieving information from a database that stores information regarding commercially available components, in an embodiment. For example, as discussed above, the model generation module 108 may be configured to retrieve and utilize information from the components database 116.

At block 220, one or more models are generated that correspond to one or more candidate designs that implement the determined design function. Block 220 may include constructing each model from one or more sub-models corresponding to one or more components determined at block 216. For example, as discussed above, the model generation module 108 may be configured to generate one or more models that implement the determined design function, including constructing each model from one or more sub-models corresponding to one or more components.

At block 224, the model(s) generated at block 220 are evaluated with regard to one or more design objectives. For example, as discussed above, the design evaluation module 120 may be configured to evaluate models with regard to one or more design objectives. In an embodiment, the one or more design objectives are identified from the description as described above. In an embodiment, the one or more design objectives are identified based on the design corresponding to the model. For example, in an embodiment, the design evaluation module 120 may be configured to identify design objectives that correspond to particular models, systems-of-components, etc.

At block 228, a report is generated that provides at least one of i) information regarding performance of at least one candidate design with regard to the identified one or more design objectives, and ii) an indication that no candidate design meets the one or more design objectives, when appropriate. For example, as discussed above, the report generation module 124 may be configured to generate such reports.

In some embodiments, the method 200 optionally may include providing guidance for further analyzing the one or more models generated at block 220. For example, as discussed above, the report generation module 124 may be configured to provide further objectives common to models with a given specification. In some embodiments, guidance provided by the report generation module 124 may be open-ended, such as recommending one or more additional discovery processes to provide additional information

The product design system 100 and the method 200 may be implemented using one or more processors in a single computer, in a network of computers, in a client-server system, in a cloud-based system, etc. The one or more processors, in some embodiments, may execute machine readable instructions that, when executed by the one or more processors, cause the one or more processors to perform various acts and/or functions.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” or the phrase “in an embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

At least some of the various blocks, operations, and techniques described above may be implemented utilizing hardware, a processor executing firmware instructions, a processor executing software instructions, or any combination thereof. When implemented in hardware, the hardware may comprise one or more of discrete components, an integrated circuit, an ASIC, a programmable logic device, etc. When implemented utilizing a processor executing software or firmware instructions, the software or firmware instructions may be stored in any tangible, non-transitory computer readable medium or media such as a magnetic disk, an optical disk, a tape drive, a RAM, a ROM, a flash memory, a memory of a processor, etc. Likewise, the software or firmware instructions may be delivered to a user or a system via any known or desired delivery method including, for example, on a tangible, non-transitory computer readable medium or media, or via communication media. The software or firmware instructions may include machine readable instructions that, when executed by the processor, cause the processor to perform various acts.

Upon reading this disclosure, those of skill in the art will appreciate still additional alternative structural and functional designs for a system and a process for product design through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for generating a product design, the method comprising:
receiving, at one or more computer processors, a description of at least one of i) a product to be designed, or ii) one or more design objectives corresponding to the product to be designed;
analyzing, at one or more computer processors, the description to determine a design function that corresponds to the description and characterizes the product;
determining, at one or more computer processors, one or more combinations of sub-functions that match the determined design function;
determining, at one or more computer processors, a plurality of components that implement the design sub-functions;
generating, at one or more computer processors, one or more models that correspond to one or more candidate designs that implement the determined design function, including constructing each model from one or more sub-models corresponding to one or more components among the determined plurality of components;
evaluating, at one or more computer processors, the generated one or more models with regard to one or more design objectives; and
generating, at one or more computer processors, a report that provides at least one of i) information regarding performance of at least one candidate design with regard to the one or more design objectives, and ii) an indication that no candidate design meets the one or more design objectives, when appropriate.

2. The method of claim 1, further comprising analyzing, at one or more computer processors, the description to identify at least some of the one or more design objectives.

3. The method of claim 1, wherein the description is expressed at least partially in natural language.

4. The method of claim 1, wherein the description is expressed at least partially using a computer readable language having a precise syntax.

5. The method of claim 1, wherein the description is expressed at least partially using a table.

6. The method of claim 1, wherein the description is expressed at least partially via one or more menu selections made by a user.

7. The method of claim 1, wherein the description includes at least one of:
i) a graphical depiction of the product to be designed; or
ii) a graphical representation of one or more components of the product to be designed.

8. The method of claim 1, wherein the description includes at least one of:
i) partial technical design information of the product;
ii) technical design information of one component of the product; or
iii) partial technical design information of the one component of the product.

9. The method of claim 1, wherein:
determining the plurality of components that implement the design sub-functions comprises searching a database system storing information corresponding to commercially available components;
the method further comprises retrieving, from the database system, one or more sub-models corresponding to one or more commercially available components; and
generating the one or more models that correspond to the one or more candidate designs includes using the one or more sub-models corresponding to one or more commercially available components.

10. The method of claim 1, wherein evaluating the generated one or more models to with regard to the one or more design objectives comprises utilizing information regarding factors external to the candidate design.

11. The method of claim 10, wherein factors external to the candidate design include one or more of:
an environment in which the product will be, or is expected to be, used;
a material that the product will, or is expected to, use in operation;
a system in which the product will be, or is expected to be, implemented; and
a condition under which the product will be, or is expected to be, operated.

12. A system for generating a product design, the system comprising:
a database of sub-models corresponding to components capable of being assembled into products;
a design description analysis module configured to analyze a received description to determine a design function that corresponds to the description and characterizes the product, wherein the description is of at least one of i) a product to be designed, and ii) one or more design objectives corresponding to the product to be designed; and
a model generation module coupled to the database and the design description analysis module, the model generation module configured to:
determine one or more combinations of design sub-functions that match the determined design function,
determine a plurality of components that implement the design sub-functions, and
generate one or more models that correspond to one or more candidate designs that implement the determined design function, including constructing each model from one or more sub-models corresponding to one or more components among the determined plurality of components;
a design evaluation module coupled to the model generation module, the design evaluation module configured to evaluate the generated one or more models to with regard to one or more design objectives; and
a report generation module coupled to the design evaluation module, the report generation module configured to generate a report that provides at least one of i) information regarding performance of at least one candidate design with regard to the one or more design objectives, and ii) an indication that no candidate design meets the one or more design objectives, when appropriate.

13. The system of claim 12, wherein the design description analysis module is configured to analyze the description to identify at least some of the one or more design objectives corresponding to the product.

14. The system of claim 12, wherein the product design objectives module includes a natural language processing module configured to analyze one or more portions of the description expressed at least partially in natural language.

15. The system of claim 12, wherein:
the description is expressed at least partially using a computer readable language having a precise syntax; and
the product design objectives module is configured to analyze the computer readable language.

16. The system of claim 12, wherein:
the description is expressed at least partially using a table; and
the product design objectives module is configured to analyze the table.

17. The system of claim 12, wherein:
the product design objectives module is configured to prompt a user with one or more menus; and
the description is expressed at least partially via one or more menu selections of the user.

18. The system of claim 12, wherein:
the description includes graphical data corresponding to at least one of:
i) a graphical depiction of the product to be designed, or
ii) a graphical representation of one or more components of the product to be designed; and
the product design objectives module is configured to analyze the graphical data.

19. The system of claim 12, wherein:
the description includes technical design information corresponding to at least one of:
i) a partial design of the product,
ii) one component of the product, or
iii) a partial design of the one component of the product; and
the product design objectives module is configured to analyze the technical design information.

20. The system of claim 12, wherein
the database stores information corresponding to commercially available components; and
the model generation module is configured to:
determine the plurality of components that implement the design sub-functions based on searching the database,
retrieve, from the database, one or more sub-models corresponding to one or more commercially available components, and
generate the one or more models that correspond to the one or more candidate designs using the one or more sub-models corresponding to one or more commercially available components.

21. The system of claim 12, wherein the design evaluation module is configured to utilize information regarding factors external to the candidate design when evaluating the generated one or more models.

22. The system of claim 21, wherein factors external to the candidate design include one or more of:
an environment in which the product will be, or is expected to be, used;
a material that the product will, or is expected to, use in operation;
a system in which the product will be, or is expected to be, implemented; and
a condition under which the product will be, or is expected to be, operated.
